(19) United States
(12) Patent Application Publication
(10) Pub. No.: US 2008/0233545 A1
(43) Pub. Date: Sep. 25, 2008

(54) SYSTEM AND METHOD FOR SIMULTANEOUSLY ADVERTISING CONSUMER PRODUCTS AND SERVICES AND EDUCATING STUDENTS

(76) Inventor: Daniel C. Yeager, Iowa City, IA (US)

Correspondence Address: SIMMONS PERRINE PLC, THIRD FLOOR TOWER PLACE, 22 SOUTH LINN STREET, IOWA CITY, IA, 52240, US

(21) Appl. No.: 12/050,684

(22) Filed: Mar. 18, 2008

Related U.S. Application Data
(60) Provisional application No. 60/895,872, filed on Mar. 20, 2007.

(51) Int. Cl. G09B 19/18

(52) U.S. Cl. 434/107

(57) ABSTRACT

A system and method for simultaneously advertising and educating students which uses a corporate sponsor of consumer products or service which pays for a modular hands-on real-life simulation of an occasion for encountering the products or service and provides ability to learn and to permit revenue sharing via an internet teaching and testing component.

### CROSS REFERENCE TO RELATED APPLICATIONS

This application claims the benefit of the filing date of co-pending provisional patent application entitled “SYSTEM AND METHOD FOR SIMULTANEOUSLY EDUCATING STUDENTS AND ADVERTISING CONSUMER PRODUCTS AND SERVICES”, having Ser. No. 60/895,872, which was filed on Mar. 20, 2007, by Daniel C. Yeager. which provisional patent application is incorporated herein in its entirety by this reference.

### FIELD OF THE INVENTION

The present invention generally relates to advertising consumer products and services and teaching students about the same.

### BACKGROUND OF THE INVENTION

In recent years, attempts at simultaneously advertising and educating school-age children about consumer products and services have been dominated by television commercials. However, with the high cost of television advertising, the commercials are generally limited in duration and, therefore, content.

Typically, these commercials must capture the attention of the child and keep their attention and deliver only the most critical information. Often these commercials depict the product or service as being fun or tasting good. Much effort is often expended to make it appear that owning or consuming the goods or services is enjoyable.

While television commercials have been tremendously successful at advertising some consumer products and services and educating children about those products, it is difficult to convey subtleties of taste, enjoyment, etc. Additionally, television has not proven to maximize the educational aspects for many products because of the time limitations and the need to keep the child's attention in the passive environment of television.

Consequently, there exists a need for improved methods and systems for simultaneously advertising consumer products and services and more thoroughly educating children about the same.

### SUMMARY OF THE INVENTION

It is an object of the present invention to provide a system and method for simultaneously advertising and educating students about consumer products and services.

It is a feature of the present invention to utilize a process simulating a real-life experience through role playing with “hands-on” teaching aids.

It is another feature of the present invention to include self-storing, lockable and tamper-resistant rollaway boxes containing consumer products and a model of a real-life situation where consumer products and/or services are encountered.

It is yet another feature of the present invention to provide advertising opportunities associated with the real-life situations by providing an opportunity of delivery of actual free unit sample consumables with advertising and education material thereon in a learning environment.

It is another feature of the present invention to include a revenue-sharing model whereby a provider of consumer products and/or services shares revenue with an educational or civic institution which carries out the simulation experience.

It is another feature of the present invention to include an option of providing an associated internet or worldwide web-based testing and in-depth study component.

It is an advantage of the present invention to simultaneously achieve advertising and education of students of consumer products and services in a convenient, affordable and enjoyable manner.

The present invention is a system and method for simultaneously advertising and educating students about products and services, which invention is designed to satisfy the aforementioned needs, provide the previously stated objects, include the above-listed features, and achieve the already articulated advantages.

Accordingly, the present invention is a system and method including a tangible hands-on simulation of a real-life experience involving consumer products and services, together with an internet-based ancillary teaching component.

### DETAILED DESCRIPTION OF THE INVENTION

The following description is focused upon the system and method of the present invention in association with children in an educational institution or setting and with consumer goods and services. It should be understood that this use of children in educational institutions and consumer goods, etc. are merely an example, and other ages of people and institutions and settings and other goods, services or activities are contemplated, including but not limited to adults and recreational, fundraising, and religious systems for civic, church or other groups.

In a first step, a corporate sponsor, such as a bank, grocery store chain, department store, packaged food manufacturer, or any other type of person, entity or business could be a sponsoring organization. The sponsoring organization could pay for the acquisition of various consumer learning modules, (hereafter CLMs) which could be modules for retail store shelves, point-of-sale stations, teller windows, customer service desks, or shopping carts. The details of these educational and consumer products and services-related CLMs need to be discussed in-depth as they have been improved from their original design which was used in the United States for several years by Yeager Instruments Inc. of 2050 Keokuk Street, Iowa City, Iowa 52240. The new CLMs are made to be transportable in a delivery van, as they have a length less than 94″ and width of less than 48″ and a thickness of less than 18.″ These boxes can be made in full size or half size and are designed to be either stacked or not stacked.

The corporate sponsor fills the CLMs with sponsored merchandise. Preferably, the sponsored merchandise is sample items of the actual product, clearly showing the logos, brand names, etc. and contains free samples therein. For example, small dry cereal boxes could be used.

In a second step, the educational institution, which could be a school, day care, community group or any other appropriate similarly-minded group, uses the simulation kits to teach predetermined skills, including, but not limited to, consumer skills to children. This could be done as a stand-alone program or as a hands-on reinforcement session of an existing curriculum.

The free samples could be given away to participants of the simulation. If they also are marked with nutritional, price and volume information, they can be used to teach the students about nutrition, value, etc. The corporate sponsor could replenish the store shelves with new sample products as needed after depletion or after each simulation session.

In a third step, the corporate sponsor alone or in cooperation with the school provides a post-simulation study guide and testing website where students and parents can go to find out more information about the simulation and the sponsored merchandise. An online test could be provided here to test the children's level of competence with the skills being taught in the simulation.

In a fourth step, the corporate sponsor could pay the school for traffic that is being driven to the website. Presumably, the advertising located on the website will justify the payment for traffic to the website.

In a fifth step, the corporate sponsor could pay the children participants for going to the study guide or test page.

In a sixth step, the corporate sponsor could pay the children for successfully passing the online interactive test. This payment could be in the form of cash or other valuables, such as store credit, coupons, discounts, etc. The reward for passing the test could provide encouragement to study the material by paying less for passing if it is done with increasing numbers of attempts or more for getting a score which is significantly higher than the reward threshold.

The steps of the present invention could be carried out using one or more of the CLMs, together with simulation participant computers and a web server configured to provide the online test to the simulation participants, as well as other software configured to determine the traffic on the web server, as well as any combination of networked computers which would be deemed to be helpful by a person possessing ordinary skill in the art.

The foregoing description assumes that the sponsor may be dealing directly with the educational institution or recipient. However, it should be understood that in an alternate embodiment of the present invention, the manufacturer of the CLMs or a third party (hereafter the “system administrator”) may be a liaison between the sponsor and the educational institution (recipient). In such embodiments the system administrator will e.g. help the sponsor select the schools to target and will coordinate use of the CLMs across several schools and even in multiple school districts. Once an agreement (which could be a simple percentage fee for handling products, services, creating and maintaining web pages, etc.) is in place between the system administrator and the sponsor, the burden of administering the system can be borne by the system administrator with reduced non-financial involvement of the sponsor.

Also, the above description describes embodiments where the consumer goods might be packaged edible goods. It should be understood that in some embodiments and in some situations it might be preferred to have the sponsored merchandise be empty boxes or items which are inoperable. This may help focus the attention of the students upon the tasks being taught and not some much on the other aspects or features of the merchandise.

### DEFINITIONS

The term “self-storing” is used throughout this description and is intended to be construed in the claims as the ability for the object itself to form all or a portion of its own container.

The term “sponsored merchandise” is used throughout this description and is intended to be construed in the claims as merchandise which is a part of the educational program but which also is a real sample of goods or a representative box etc. provided by the corporate sponsor and which goods or boxes are provided with trademarks of the corporate sponsor.

The term “modular rollaway container” is used throughout this description and is intended to be construed in the claims as the ability for the device to be rolled in and out of a regular doorway and capable of being rolled down a school hallway by a student and sized and configured to be stored adjacent one another in either a stacked or non-stacked configuration.

The term “simulation testing website” is used throughout this description and is intended to be construed in the claims as a website which contains, among other things, an online test to assess the competence of the students either before or after being involved in the simulation.

The term “less-than-cost charge” is used throughout this description and is intended to be construed in the claims as meaning at a charge to the recipient less than full cost to the corporate sponsor of providing the item to the recipient. The charge to the recipient shall mean the total charge to the recipient less any remuneration of any kind provided by the corporate sponsor to the recipient for any reason.

It is thought that the method and apparatus of the present invention will be understood from the foregoing description and that it will be apparent that various changes may be made in the form, construct steps, and arrangement of the parts and steps thereof, without departing from the spirit and scope of the invention or sacrificing all of their material advantages. The form herein described is merely a preferred exemplary embodiment thereof.

I claim:

1. A method of simultaneously advertising consumer products and service and teaching students about the consumer products and services, comprising the steps of:
providing to an education institution, at a less-than-cost charge, a simulation kit comprising:
a self-storing modular rollaway structure, and
a plurality of items of sponsored merchandise, sized and configured to be stored within said self-storing modular rollaway structure, when said self-storing modular rollaway structure is in a stowed configuration taking the shape of a rectangular box;
using the simulation kit to perform a simulation of a predetermined consumer activity;
providing to participants of the simulation which uses the simulation kit, a simulation testing website configured for administering an online interactive test for assessing a student's level of competence with a predetermined consumer skill which is directly related to the sponsored merchandise;
providing financial remuneration to the education institution for cumulative traffic upon the simulation testing website;
providing financial remuneration to participants of the simulation for their browsing activity occurring at the simulation testing website; and
providing financial remuneration to participants of the simulation for performance on the online interactive test which exceeds a predetermined threshold.

2. A method of claim 1 wherein the less-than-cost charge is free of charge.

3. The method of claim 1 wherein the self-storing modular rollaway structure is a merchandise rack in combination with a point-of-sale structure.

4. The method of claim 1 wherein the sponsored merchandise comprises packaged edible products.

5. The method of claim 1 wherein the predetermined consumer activity comprises retail purchasing of consumer goods.

6. The method of claim 1 wherein the online interactive test is a multiple choice test.

7. The method of claim 1 wherein the step of providing financial remuneration to a participant of the simulation for performance on the online interactive test which exceeds a predetermined threshold further comprises determining a maximum test reward amount and dividing such maximum test reward by a number representing the total number of attempts made by the participant.

8. A method of claim 7 wherein:
the less-than-cost charge is free of charge;
the sponsored merchandise comprises packaged edible products;
the self-storing modular rollaway structure is a merchandise rack in combination with a point of sale structure;
the predetermined consumer activity comprises retail purchasing of consumer goods;
the online interactive test is at least in part a multiple choice test;
the education institution is a plurality of schools comprising a public elementary school and a parochial school, which receive the simulation kit in series; and
the financial remuneration provided to the education institution is cash.

9. A method of claim 1 further comprising the steps of:
providing a half-sized simulation mini-kit which has length and width dimensions substantially half of the size of the simulation kit.

10. A system for simultaneously advertising consumer products and service and teaching students about the consumer products and services, comprising the steps of:
means for simulating comprising:
means for self storing a modular rollaway structure, and
means for communicating brand information and identity, sized and configured to be stored within said means for self storing a modular rollaway structure, which said means for self storing a modular rollaway structure is in a stowed configuration;
means for providing to participants of a simulation which uses the means for simulating, a simulation testing website configured for administering an online interactive test for assessing a student's level of competence with a predetermined consumer skill which is directly related to the sponsored merchandise;
means for providing financial remuneration to the education institution for cumulative traffic upon the simulation testing website;
means for providing financial remuneration to participants of the simulation for their browsing activity occurring at the simulation testing website;
means for providing financial remuneration to participants of the simulation for performance on the online interactive test which exceeds a predetermined threshold.

11. A method of simultaneously advertising consumer products and service and aiding persons with an activity, comprising the steps of:
providing to a recipient a substantially free simulation kit comprising:
a self-storing modular rollaway structure, and
a plurality of items sized and configured to be stored within said self-storing modular rollaway structure, which said self-storing modular rollaway structure is in a stowed configuration;
using the simulation kit to perform a simulation of a predetermined activity;
providing to participants of the simulation which uses the simulation kit, a simulation testing website configured for providing in-depth information which is directly related to one of a first predetermined product and a second predetermined service;
providing financial remuneration to the recipient for cumulative traffic upon the simulation testing website;
providing financial remuneration to participants of the simulation for their browsing activity occurring at the simulation testing website;
providing financial remuneration to participants of the simulation for performance on the online interactive test which exceeds a predetermined threshold.

12. The method of claim 1 wherein simulation testing website is further configured to test a student with food product comparisons based upon a cost per calorie characteristic.

13. The method of claim 8 further comprising the steps of:
providing to a sponsor an agreement whereby the sponsor agrees to pay for the simulation kit which is then provided to a plurality of education institutions in series.

14. The method of claim 8 wherein the self-storing modular rollaway structure is configured with dimensions of a length of less than 96″, a width of less than 48″ and a thickness of less than 18″ when in a stowed configuration.
